(19) United States
(12) Patent Application Publication
(10) Pub. No.: US 2024/0312133 A1
(43) Pub. Date: Sep. 19, 2024

(54) Rolling Out a Virtual Environment to a Person

(71) Applicant: Bayerische Motoren Werke Aktiengesellschaft, Muenchen (DE)

(72) Inventors: Joscha EIRICH, Muenchen (DE); Ingmar STAPEL, Ismaning (DE)

(21) Appl. No.: 18/603,422

(22) Filed: Mar. 13, 2024

(30) Foreign Application Priority Data
Mar. 14, 2023 (DE) 10 2023 106 281.6

(51) Int. Cl. G06T 17/00

(52) U.S. Cl. CPC G06T 17/00

(57) ABSTRACT

A method for rolling out a virtual environment to a person encompasses steps of determining a weather prevailing in the region of a predetermined real environment; and rolling out a virtual environment to a person, the virtual environment being rolled out on the basis of the determined weather.

### CROSS REFERENCE TO RELATED APPLICATION

This application claims priority under 35 U.S.C. § 119 from German Patent Application No. 10 2023 106 281.6, filed Mar. 14, 2023, the entire disclosure of which is herein expressly incorporated by reference

### BACKGROUND AND SUMMARY

The present invention relates to the rolling out of a virtual environment to a person. In particular, the invention relates to improved realistic rollout of the virtual environment.

A virtual environment can be created on the basis of stored data or a model and rolled out to a person. The environment can be rolled out to the person in particular visually or audibly, with the result that as realistic as possible an effect of the person being situated in the virtual environment is produced. A virtual environment can also be called virtual reality or VR. To improve the realism of the impression of the virtual environment for the person, they can wear VR goggles or a VR helmet configured to present them with visual and/or audible stimuli. The person is then preferably shielded from picking up applicable stimuli from their actual environment. This technique can be used not only for computer games but also for a simulation or as a digital tool in industry, science or art.

The virtual environment may be associated with a real environment. By way of example, as part of a simulation the person can be taken to a location that is dangerous to actually enter, for example an industrial plant where there has been an accident. The virtual environment may be modelled on the real environment of the industrial plant.

In another embodiment, one or more aspects of the virtual environment may differ from a real environment. By way of example, the person may have an associated virtual person (avatar), the appearance and/or abilities of which may not correspond to those of the user. Different users can interact with one another as a result of their avatars interacting with one another.

A virtual environment can have a more realistic effect if the interaction of detectable stimuli and information yields a uniform picture. A real environment is constantly subject to influences and changes, the absence of which in a virtual environment may be perceived as unrealistic.

An object on which the present invention is based is to provide an improved technique for rolling out a virtual environment to a person. The invention achieves the object by means of the subjects of the independent claims. Dependent claims describe preferred embodiments.

According to a first aspect of the present invention, a method for rolling out a virtual environment to a person encompasses steps of determining a weather prevailing in the region of a predetermined real environment; and rolling out a virtual environment to a person, the virtual environment being rolled out on the basis of the determined weather.

The virtual environment can be rolled out to the person in particular in such a way that the person better gets the impression that the weather is prevailing in the virtual environment. The virtual environment can be detected or perceived by the person more realistically in this way. The person is therefore better able to address a predetermined activity in the virtual environment. A distraction as a result of unrealistic impressions, inconsistent or conflicting information regarding the virtual environment can be avoided. By way of example, the method can be used to simulate an activity of the person in a predetermined real environment. By way of example, the activity may encompass driving a machine, for instance a construction machine or a motor vehicle, operating a plant or exploring a predetermined location.

The weather can have a significant influence on the depicted virtual environment. For example, light conditions can change when clear weather is prevailing or rays of the sun are held back by clouds. Good visibility can be impaired by fog or darkness, for example. The environment may be subject to precipitation that can be detected visually or audibly, for example. Additionally, the weather can influence other depicted objects. Rain can make the objects appear wet, and snow can accumulate on the objects. A ground on which the user appears to be standing can become slippery, slushy or boggy as a result of precipitation. This can influence the ability of the person to act in the virtual environment.

It is preferred for the environment to be rolled out to the person immersively. This can be accomplished by using an output apparatus that eliminates inconsistent information if possible. In particular, the perception of information from a real environment of the person can be stopped. The virtual environment is preferably offered to the person on two or more sensory channels. For example, the virtual environment can be imparted visually and audibly. In other embodiments, other human senses can be triggered.

In one embodiment, the person is situated in the real environment associated with the virtual environment. A weather that is actually able to be perceived by the person may also prevail in the virtual environment in this case. In one embodiment, this is accomplished by determining a geographical position of the person, and the prevailing weather is determined for the geographical position. Whether the user is actually able to perceive the weather prevailing in their region is dependent for example on whether they are in a building or in a vehicle. Accordingly, the perceptibility of the weather in the virtual environment may be influenced by whether the avatar of the person is subject to the weather or for example is aboard an aircraft or in a building.

More preferably, the virtual environment is referenced to a predetermined time. The weather prevailing at the predetermined time is determined and taken as a basis for rolling out the virtual environment. The predetermined time may correspond to a current time in the region of the person. Alternatively, a past time can also be applied. In another embodiment, the time may also be in the future, for example on a subsequent day. The selected time may influence a position of the sun in the region of the virtual environment. The weather prevailing there may influence the visibility of the sun. As such, the time and weather may influence the perceptible virtual environment together.

If the predetermined time is in the future, the weather prevailing at the predetermined time can be determined on the basis of a weather forecast. The weather forecast is normally based on current and/or historical weather data. Normally, a weather forecast is reliable in the range from a few days to no more than approximately one week.

The weather prevailing at the predetermined time can also be determined on the basis of historical weather data in the real environment. If the historical weather data are available for a time determined in the past, they can be used immediately. If necessary, available weather data can be interpolated or extrapolated in order to determine the prevailing weather at the predetermined time. The extrapolation can be used in particular to determine the prevailing weather at a future time.

In another embodiment, the weather prevailing at the predetermined time can be determined on the basis of a weather model. The weather model may additionally take account of historical weather data and/or a weather forecast. In particular if the predetermined time is further away from a time at which reliable weather data are available, the weather model may be encompassed by a climate model. As such, the weather at a time long ago can also be at least approximately determined. By way of example, the predetermined time may date back to before when weather data began to be recorded or to prehistoric times. A climate model can also be taken as a basis for determining weather data that may have applied several tens of millions of years ago. Fauna and flora of the virtual environment can likewise be determined on the basis of models.

According to another aspect of the present invention, a computer program encompasses program code configured to perform a method as described herein when the computer program product is executed on a processing device.

According to another aspect of the present invention, a computer-readable data carrier encompasses program code configured to perform a method as described herein when the program code is executed on a processing device.

According to yet another aspect of the present invention, an apparatus for rolling out a virtual environment to a person encompasses a data memory containing weather data relating to a predetermined real area; an interface for determining a geographical position in the area; and a processing device. The processing device is configured to roll out the virtual environment in consideration of a weather prevailing at the geographical position.

The virtual environment may be associated with an environment in the region of the geographical position in the real area. The apparatus can preferably be used to perform a method as described herein. To this end, the processing device may be in particular of electronic design, for example in the form of a microcomputer or microcontroller. Advantages or features of the method and the apparatus may be applicable in each case.

In a more preferred embodiment, the apparatus additionally encompasses a device for determining a geographical position of the person. As such, the current geographical position of the person can be taken as a basis for determining the weather prevailing in the region of the virtual environment. By way of example, the device may encompass a receiver for signals of a satellite-assisted navigation system (GNSS). In another embodiment, an approximate geographical position of the person can be determined on the basis of communication in a network. For example, the person can use a device that is registered in a mobile radio network. The position of the device can then be determined approximately on the basis of a receiving station that is communicating with the device. In yet another embodiment, the device may have a network address for which at least an approximate geographical position can be determined. An example of such a network address may relate to an IP address in version 4 or 6.

In another continuation, the apparatus may encompass a device for imparting a prevailing weather to the person. The device can use an additional sensory channel to improve the immersive experience of the person. For example, a radiant heater can be used to simulate the influence of sunshine in the virtual environment. A sprinkler system can be used to simulate precipitation. A fan can impart wind, the temperature of which can optionally be controlled. As such, the fan may be encompassed by an air-conditioning system or a fan heater. Such devices are easy to implement and, by imparting aspects of a prevailing weather, are better able to put the person into the virtual environment.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system; and

FIG. 2 illustrates a flowchart for a method.

### DETAILED DESCRIPTION OF THE DRAWINGS

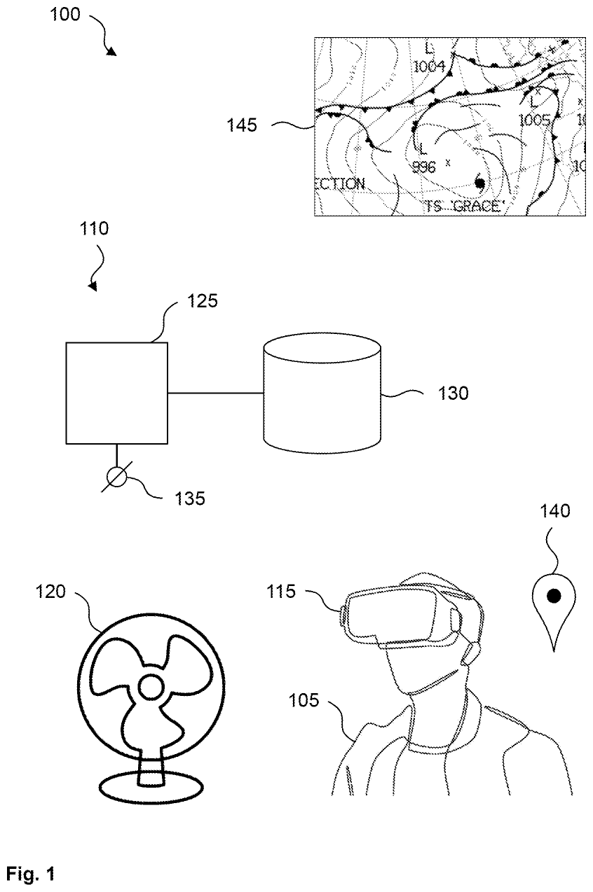

FIG. 1 shows a system 100. The system 100 is configured to provide a person 105 with as realistic an impression of virtual surroundings as possible.

The system 100 encompasses an apparatus 110 and at least one output apparatus for outputting a sensory stimulus to the person 105. VR goggles 115 and a fan 120 are depicted by way of illustration. The VR goggles 115 are configured to supply visual and possibly also audible signals to the person 105. The fan 120 is configured to produce the sensation of an air movement for the person 105. The fan 120 may be mobile relative to the person 105 in order to produce wind from different directions. In other embodiments, the strength of the supplied wind, a temperature and/or transported precipitation can be controlled.

The apparatus 110 preferably encompasses a processing device 125 having a data source 130. Additionally, there is preferably provision for an interface 135 that can be used to connect a terminal associated with the user 105. This can include the apparatuses 115, 120, for example. Additionally, the interface 135 can be used to determine a geographical position 140 of the person 105.

The data source 130 is configured to supply weather data 145 from a predetermined real area. To this end, applicable weather data for a predetermined period may be stored. By way of example, the weather data 145 may have been produced on the basis of weather stations, weather ships, weather aircraft or weather satellites. The data source 130 may also encompass an external weather service. Further, the data source 130 may encompass a sensor that can be used to determine a prevailing weather. There may be provision for multiple sensors at different geographical positions.

It is proposed that the apparatus 110 be configured to roll out a virtual environment to the person 105 on the basis of weather data prevailing at a position associated with a predetermined real position. The real position may encompass in particular the geographical position 140 of the person 105. In another embodiment, the person 105 can select a real geographical position for which a weather is determined and taken as a basis for rolling out the virtual environment. Aspects of the virtual environment and of a determined weather prevailing therein can be rolled out to the person 105 by means of the apparatuses 115, 120.

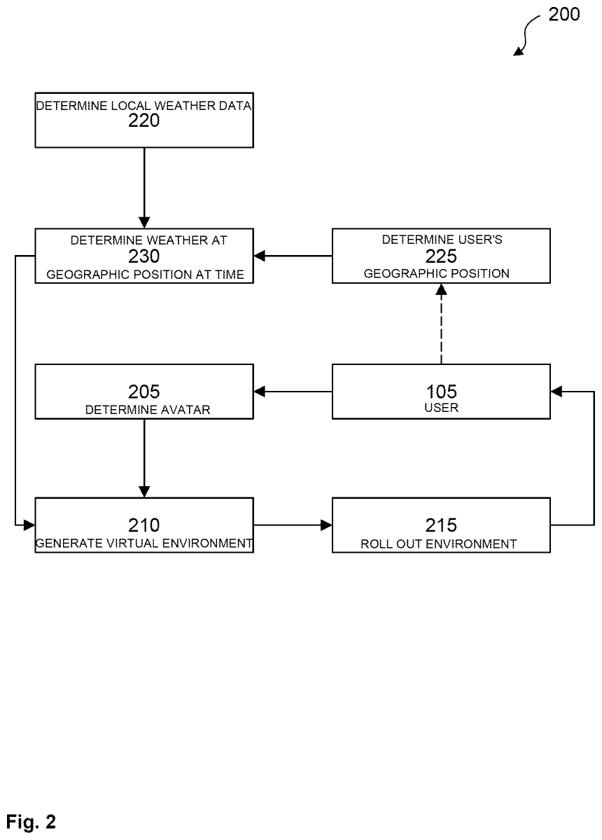

FIG. 2 shows a flowchart for a method 200 for rolling out a virtual environment to a person 105.

In a step 205, an avatar associated with the user 105 can be determined. The avatar may be situated at a predetermined position in a virtual world. In a step 210, a virtual environment of the avatar can be generated. This can be accomplished in particular by determining sensory impressions that affect the avatar at the predetermined position in the virtual world. In a step 215, the determined impressions can be given, or offered, to the user 105. The user 105 can act on the basis of the stimuli with which they are presented, their actions being able to be forwarded to the apparatus 110 as inputs. An illustrative action consists of a hand movement or a running movement. The apparatus 110 can determine an effect of the action on the virtual surroundings and consequently an altered effect of the surroundings on the avatar. In this way, a control loop may be formed to keep the user 105 in the virtual surroundings immersively for the senses.

It is proposed that weather data be determined in a step 220. The weather data can cover a predetermined geographical area. Additionally, the weather data can encompass a predetermined time range.

In a step 225, a geographical position associated with the user 105 can be determined. This may relate in particular to the geographical position 140 or to a geographical position selected by the user 105. The geographical position may also have been determined, or predefined, by the apparatus 110.

The determined geographical position and the weather data can be taken as a basis for determining, in a step 230, a weather that prevails, or has prevailed or will prevail, at the predetermined geographical position 140 at a predetermined time. A time for which the weather is determined may be part of a simulation performed by the apparatus 110.

The local weather 230 is preferably determined on the basis of current or historical weather data. In other embodiments, it can also be determined on the basis of a weather model, a climate model and/or a weather forecast.

The generation of the virtual environment in step 210 can be influenced by the local weather at the position of the virtual environment that was determined in step 230. The influence can be delivered to the user 105 directly, for example if it is wind. The influence may also be indirect, for example if the weather encompasses precipitation in the form of snow. In this case, a visibility or the appearance of an object in the surroundings may be adjusted for the precipitation.

As a result, the user 105 can get an even better impression of actually being in the virtual environment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
105 person
110 apparatus
115 VR goggles
120 fan
125 processing device
130 data memory
135 interface
140 geographical position
145 weather data
200 method
205 determine avatar
210 generate virtual environment
215 roll out environment
220 determine weather data from geographical area
225 determine geographical position
230 determine local weather

What is claimed is:

1. A method for rolling out a virtual environment to a person, the method comprising the steps of:
determining a weather prevailing in a region of a predetermined real environment;
rolling out a virtual environment to a person, wherein
the virtual environment is rolled out based on the determined weather.

2. The method according to claim 1, wherein the virtual environment is rolled out to the person immersively.

3. The method according to claim 1, wherein the person is situated in the predetermined real environment.

4. The method according to claim 1, wherein
the virtual environment is referenced to a predetermined time, and
the weather prevailing at the predetermined time is determined.

5. The method according to claim 4, wherein
the predetermined time is a future time and the weather prevailing at the predetermined time is determined based on a weather forecast.

6. The method according to claim 4, wherein
the weather prevailing at the predetermined time is determined based on historical weather data in the real environment.

7. The method according to claim 4, wherein
the weather prevailing at the predetermined time is determined based on a weather model.

8. A computer product comprising a non-transitory computer-readable medium having stored thereon program code that, when the program code is executed on a processer, carries out the acts of:
determining a weather prevailing in a region of a predetermined real environment;
rolling out a virtual environment to a person, wherein
the virtual environment is rolled out based on the determined weather.

9. An apparatus for rolling out a virtual environment to a person, comprising:
a data memory containing weather data relating to a predetermined real area;
an interface for determining a geographical position in the area; and
a processer configured to roll out the virtual environment in consideration of a weather prevailing at the geographical position.

10. The apparatus according to claim 9, further comprising:
means for determining a geographical position of the person.

11. The apparatus according to claim 10, further comprising:
means for imparting a prevailing weather to the person.
